(19) United States
(12) Patent Application Publication
(10) Pub. No.: US 2004/0144598 A1
(43) Pub. Date: Jul. 29, 2004

(54) Application device

(75) Inventors: James P. Perrone, Bolingbrook, IL (US); Craig Burns, Plainfield, IL (US)

Correspondence Address: Eric R. Moran, McDonnell Boehnen Hulbert & Berghoff, 300 S. Wacker Drive, Chicago, IL, 60606, US

(73) Assignee: SLic-STik, Inc.

(21) Appl. No.: 10/705,085

(22) Filed: Nov. 10, 2003

Related U.S. Application Data
(60) Provisional application No. 60/425,232, filed on Nov. 8, 2002.
(60) Provisional application No. 60/484,433, filed on Jul. 2, 2003.

(51) Int. Cl. F16N 7/16

(52) U.S. Cl. 184/15.1; 184/16

(57) ABSTRACT

The embodiments provide an elongate body that can vertically offset an application area. In an exemplary embodiment, the elongate body can vertically offset the application area from a hand grip. In an exemplary embodiment, the offset can facilitate placing the application area between a running belt and a top surface of a running panel of a treadmill. The application area can then be rubbed against the running panel to clean and/or lubricate the interface with the running belt.

This application claims the benefit of U.S. Provisional Application No. 60/425,232, filed on Nov. 8, 2002, and U.S. Provisional Application No. 60/484,433, filed on Jul. 2, 2003.

### BACKGROUND

1. Field of the Invention

The present invention relates to an application device, and more specifically to a device used to apply a lubricant to the interface between a running belt and a running panel that supports the running belt of treadmills.

2. Background

A treadmill can utilize a continuous running belt that can be stretched between a pair of elongate rollers mounted to a base of the treadmill. A support or running panel, which can be made of a phenolic material and/or composites, can be mounted to the base under a top portion of the running belt to support the weight of a runner. An electric drive motor, typically of the direct current type providing from about ¾ to 2 horsepower, can drive a frontmost of the rollers to overcome internal friction of the treadmill. A handhold frame can extend upwardly from the base, providing a handhold and supporting a control panel for the treadmill.

Much of the power needed from the electrical motor can be dependent on the coefficient of friction at the interface between the inside surface of the running belt and the top surface of the running panel as a runner's feet alternately impact the running belt. The interface has in the past been periodically lubricated by spraying the top surface of the running panel with silicone spray or placing small 1/16 inch diameter beads of paraffin or other wax on the running panel which flatten and smear during operation to coat the inside surface of the running belt and the top of the running panel. Alternatively, a block of paraffin or other wax may be applied by gripping in-hand and reaching under the lifted belt. All of these require lifting and possibly necessitate loosening of the running belt by loosening one or both of the rollers to permit access to the interface area. Reaching under the running belt with one's hand and arm is also potentially dangerous, especially if the treadmill is not unplugged for servicing and is inadvertently turned on.

One attempt to alleviate the problem of one's hand or arm being laced under the running belt was affixing the block of paraffin to the end of a flat wooden stick resembling a standard wooden paint stirring stick. While this solution keeps a person's hand and arm from being placed under the running belt, there are several problems. First, the ergonomics of the straight stick make it difficult to position the wax block flatly against the top surface of the running panel, which can result in narrow streaks and inadequate coverage of the running panel. Second, ergonomically it can be difficult to apply sufficient downward force to the stick to transfer wax to the running panel without injuring one's knuckles on the base of the treadmill. Third, it can be difficult to adhesively or otherwise affix a pre-poured wax block to the stick. Fourth, the stick can be uncomfortable to grip in-hand, being of a flat, non-ergonomic profile. Fifth, it might be necessary to excessively lift and possibly loosen the running belt by loosening one or both of the rollers to permit access to the interface area to use the stick to apply wax.

Thus, there is a need to provide an application device that can overcome one or more of these disadvantages.

### SUMMARY

The embodiments disclosed herein are directed to an application device. In a particular exemplary embodiment, this application is directed to a device for applying lubricant to the interface between a running belt in a treadmill and a running panel that supports the running belt. U.S. Pat. Nos. 5,913,384 and 6,071,354 provide a description of the general background and environment of exemplary application devices used with treadmills, and the disclosures of those issued patents are incorporated herein by reference as though set forth here in full.

The exemplary application device can be used advantageously to apply material, such as lubricant, to surfaces, such as the belt and deck of a treadmill. In an exemplary embodiment, the application device can apply lubricant to minimize friction between moving parts; minimize noise caused by moving parts; minimize the current draw of a system driving moving parts; minimize repair costs associated with a system of moving parts; and maximize the overall life of a system of moving parts, for example. The exemplary application device can also be used in other applications, such as to apply cleaning material or fluid to surfaces (such as the belt and deck of a treadmill, for example). Other examples are also possible.

According to an exemplary embodiment, the device can include a hand grip, which might be contoured, and a low profile application area, which might comprise a wax block or a absorptive pad, for example. The application area can be affixed to a rimmed mounting platter disposed opposite the hand grip. The hand grip and the mounting platter can be interconnected by a body that offsets the hand grip from the mounting platter. The body might be elongate (to allow the application area to reach across the width of the running belt, for example) and the offset can facilitate placing the application area between the running belt and the top surface of the running panel. The application area can then be rubbed against the running panel to lubricate the interface with the running belt.

Other examples are possible as well.

### BRIEF DESCRIPTION OF THE DRAWINGS

Exemplary embodiments of the present invention are described herein with reference to the drawings, in which:

FIG. 1 depicts a side elevation view of a prior art wax application device;

FIG. 2 depicts a bottom plan view of the wax application device taken on the line 2-2 of FIG. 1;

FIG. 3 depicts a perspective view of an exemplary application device;

FIG. 4 depicts a side elevation view of the exemplary application device taken on the line 4-4 of FIG. 3;

FIG. 5 depicts a fragmentary perspective view of the top of a contoured hand grip of the exemplary application device;

FIG. 6 depicts a fragmentary bottom perspective view of the hand grip showing the hollowed out interior;

FIG. 7 depicts a fragmentary perspective view of the top of a mounting platter of the exemplary application device;

FIG. 8 depicts a fragmentary perspective view of the bottom of the mounting platter;

FIG. 9 depicts a portion of an exemplary application device;

FIG. 10 depicts a portion of another exemplary application device;

FIG. 11 depicts yet another exemplary embodiment; and

FIGS. 11A and 11B depict detailed views of a portion of the exemplary embodiment of FIG. 11.

### DETAILED DESCRIPTION OF EXEMPLARY EMBODIMENTS

1. General Overview

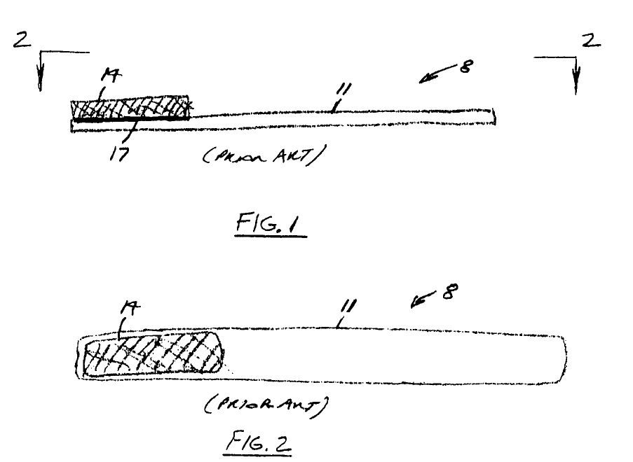

FIGS. 1 and 2 depict a prior art wax application device 8 comprising a flat wooden stick 11 with a pre-molded wax block 14 adhered thereto using a layer of adhesive 17. The device 8 is difficult to use, as explained above, and the wax block 14 tends to break free from the adhesive 17, rendering the device 8 inoperable.

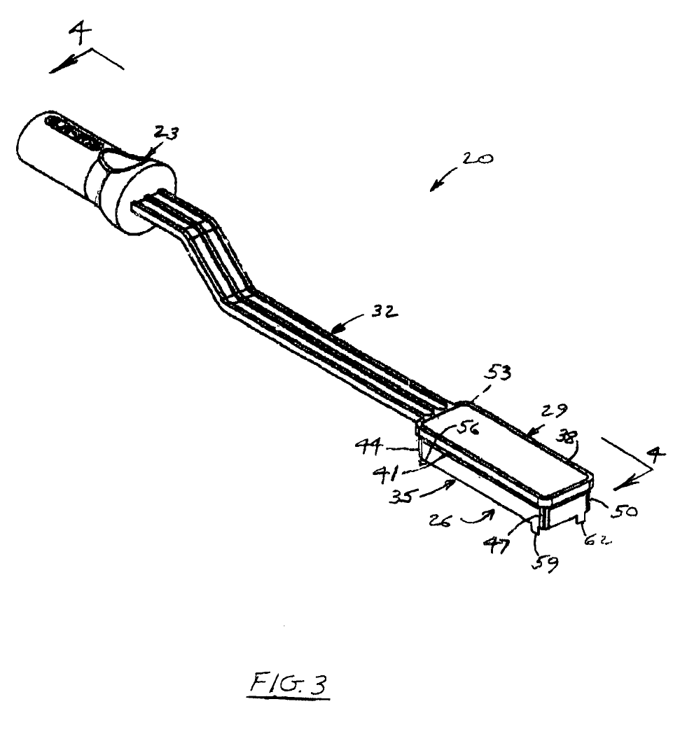

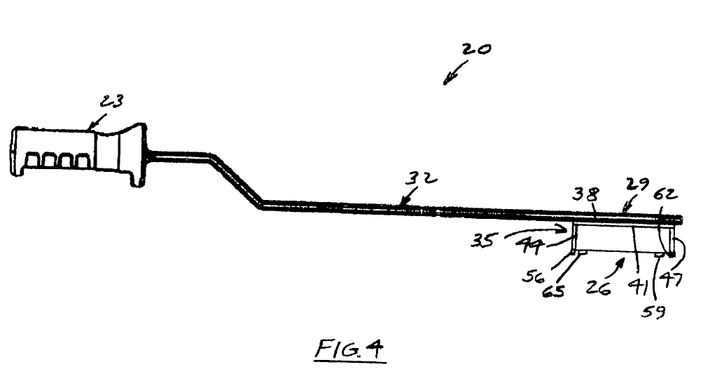

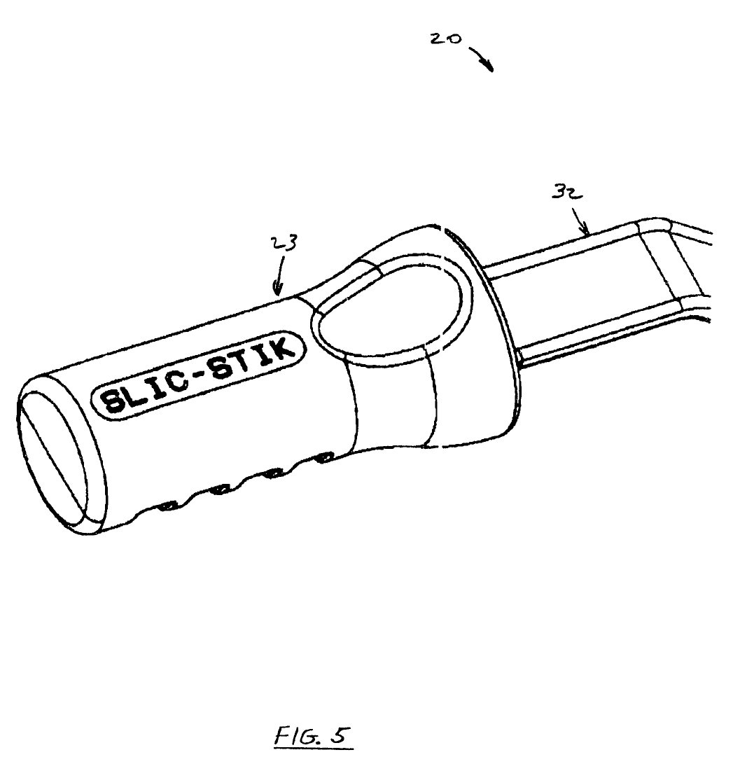

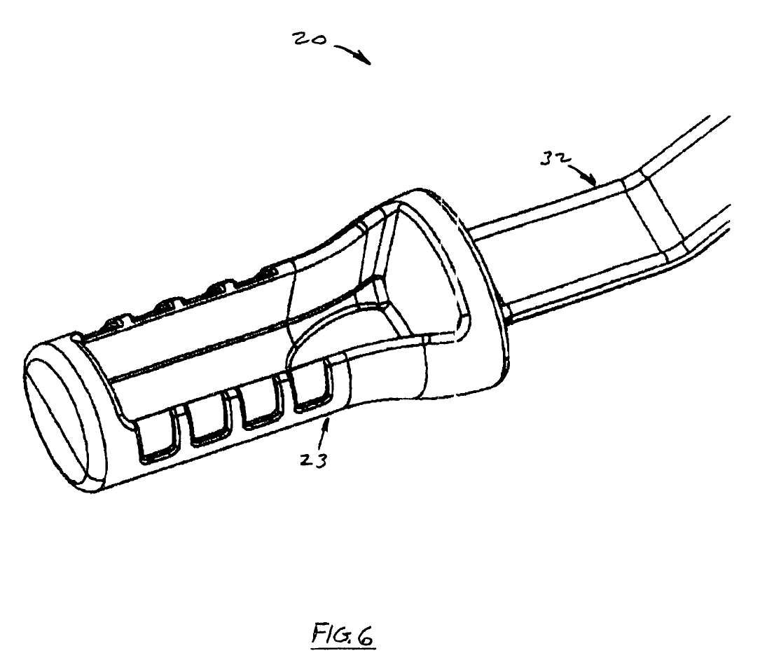

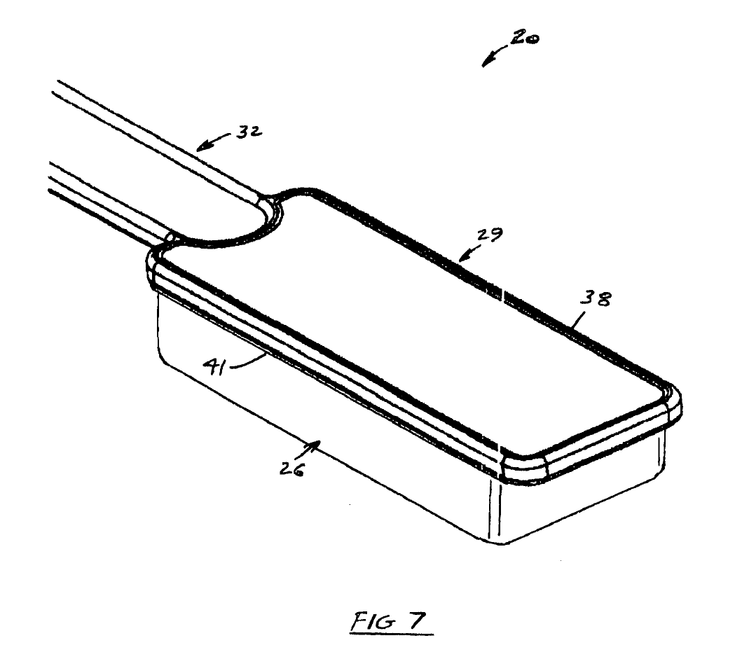

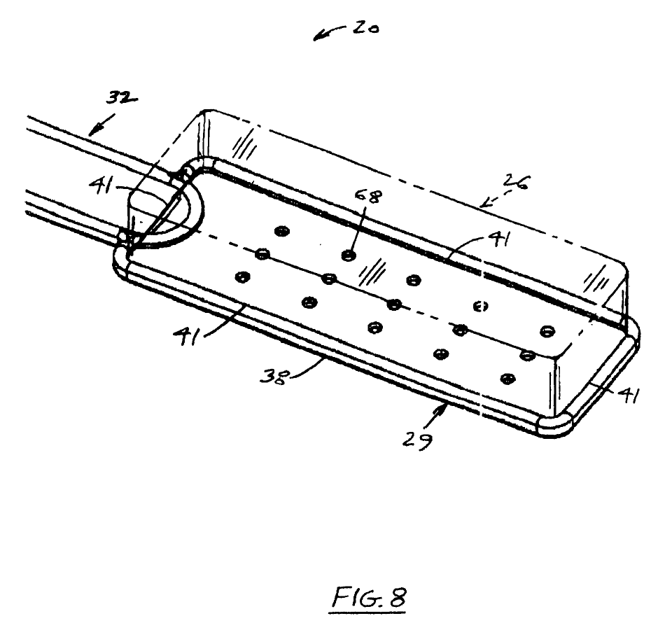

FIGS. 3-11 depict an exemplary application device 20. In an exemplary embodiment, application device 20 can include a hand grip 23, which can be contoured, and an application area 26, which can be affixed to a mounting platter 29. In an exemplary embodiment, the mounting platter 29 might be rimmed and/or partially enclose the application area 26. The hand grip 23 and the mounting platter 29 can be interconnected by a body 32, which might be elongate and which might comprise support ribs. The hand grip 23 can be hollow to reduce weight and amount of material used, and can be open to provide more clearance with the base of the treadmill during use. In an exemplary embodiment, the application device might not comprise a hand grip 23, and a user can just grip the body 32 to operate the application device 20. In other exemplary embodiments, the hand grip 23 can be integral to the body 32 or can comprise slight contours or indentations in the body 32. Other examples are possible, as well.

Any or all of hand grip 23, mounting platter 29, and body 32 can be integrally molded from plastic such as by injection or pressure molding. The application device 20, which might include the hand grip 23, the body 32, and the platter 29, might be made from a plastic material, such as polypropylene, for example. Other examples are possible as well.

Alternate exemplary embodiments of application device 20 might comprise more than one application area 26. In such a case, the application device 20 might comprise two application areas 26, and the two application areas 26 might engage opposing surfaces of the platter 29. Other examples are possible as well.

The body 32 can offset the hand grip 23 from the mounting platter 29 with the attached application area 26 to facilitate placing the application area 26 between the running belt and the top surface of the running panel. The offset might be sloped as depicted in FIG. 3, or the offset might be at a ninety degree angle from the body 32 and/or the hand grip 23. Other examples are possible, as well. In an exemplary embodiment, the application area 26 can then be rubbed against the running panel to lubricate the interface with the running belt.

The exemplary application device 20 can solve the aforementioned problems in the prior art by providing an ergonomically designed hand grip 23 and application area 26. The exemplary application device 20 can make it easy to position the application area 26 flatly against the top surface of the running panel and apply sufficient downward force, which can minimize or eliminate thin streaks and/or inadequate coverage of the running panel. Further, the exemplary application device 20 can be comfortable to grip and can eliminate excessive lifting of the running belt due to the low profile design of the mounting platter 29 and application area 26, and the body 32 may more easily be manipulated under the running belt without one's knuckles hitting the base of the treadmill.

2. First Exemplary Embodiment

In the exemplary application device 20 depicted in FIGS. 3-11, the application area 26 can comprise a material block, which might comprise a wax block, for example. In a wax block embodiment, the wax block can be paraffin based with one or more lubrication additives such as silicon, silicone, Teflon™, or graphite. To form the wax block, the wax might be heated and poured into a form wall 35, which might be removable, rounded, rectangular, thin, and downwardly dependent from a rim 38 of the mounting platter 29. The form wall 35 can include an upper thin or otherwise weakened tear line 41 and four vertical tear lines 44, 47, 50, and 53, and four gripping tabs 56, 59, 62, and 65 for tearing the form wall 35 from the mounting platter 29 after the poured wax hardens into a wax block. A plurality of adhesion bores 68 can also extend part way through the mounting platter 29 to provide greater surface area for the wax to adhere to. The wax can be poured and the form wall 35 removed following the wax hardening and prior to shipment to customers.

The pouring of the wax block directly onto the mounting platter using the form wall and the use of adhesion bores can greatly simplify the adhesion process. This can produce a wax block that is securely affixed to the mounting platter without using separately formed wax blocks that are then adhesively affixed.

3. Second Exemplary Embodiment

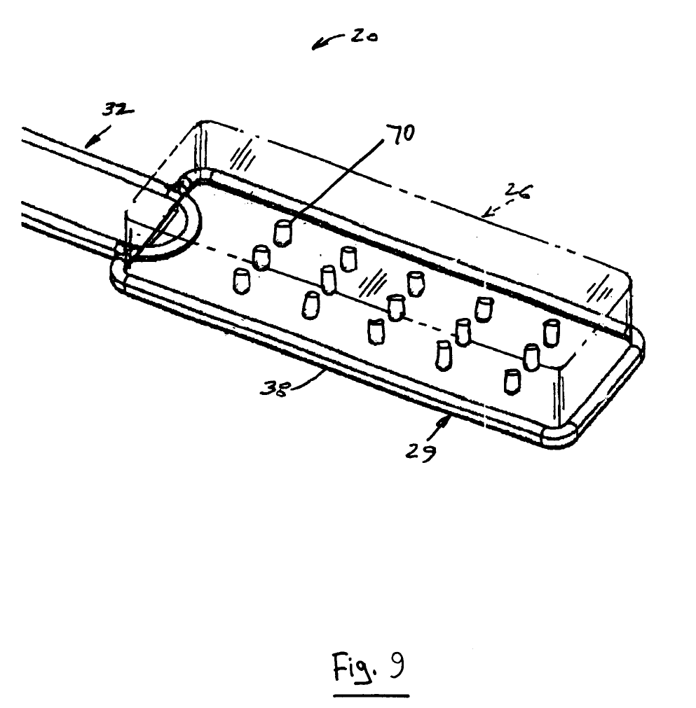

FIG. 9 depicts a portion of an exemplary application device 20. The exemplary embodiment depicted in FIG. 9 can comprise the body 32, the mounting platter 29, and the application area 26, which might comprise a material block (shown in phantom) that can engage the mounting platter 29.

As depicted in the exemplary embodiment of FIG. 9, the mounting platter 29 can comprise a plurality of extensions 70. The extensions 70 might be formed integral with the mounting platter 29 and can extend outwardly from the mounting platter 29. In such a way, the extensions 70 can increase the surface area with which the material block 26 can engage the mounting platter 29. In an exemplary embodiment, the extensions 70 might comprise three (3) rows of eight (8) extensions. Other examples are possible as well.

In an exemplary embodiment, the material block 26 might comprise a paraffin-based wax that, in turn, might comprise one or more lubrication additives, such as silicon, silicone, Teflon®, or graphite, for example. In an exemplary embodiment, the material block 26 might be formed by heating and pouring a material, such as wax, into a form (not shown in FIG. 1) that might depend from a rim 38 on the platter 29. In an exemplary embodiment, the poured material can flow around the extensions 70 and the material can engage the mounting platter 29 by, for example, adhering to the extensions 70 and the surface of the mounting platter 29. After the material has been poured, the form might also be removed.

4. Third Exemplary Embodiment

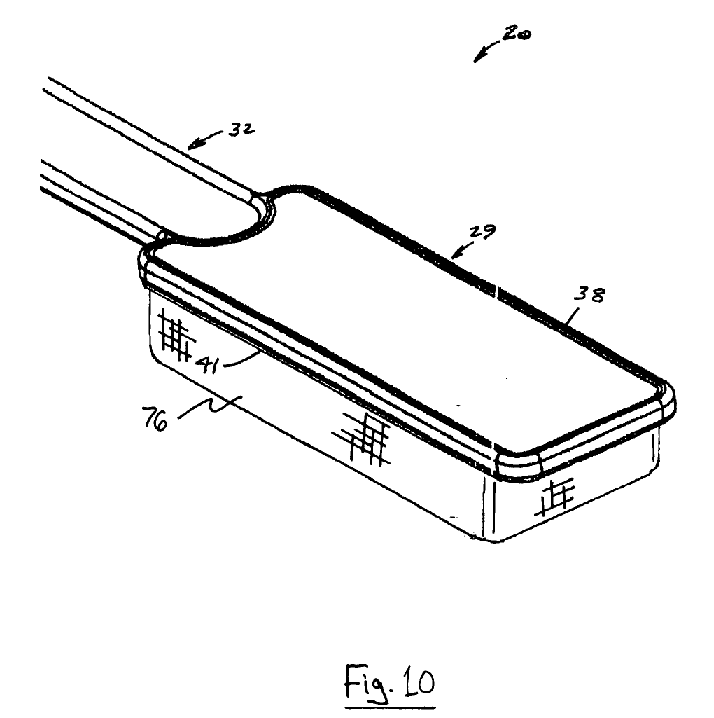

FIG. 10 depicts a portion of an exemplary application device 20. The exemplary embodiment depicted in FIG. 10 can comprise the body 32, the mounting platter 29, and an application pad 76.

As depicted in the exemplary embodiment of FIG. 10, the application pad 76 might be attached to the application device 20 at the mounting platter 29. The application pad 76 might comprise an absorptive material, such as a foam pad, and might be attached to the mounting platter via an adhesive, such as an acrylic pressure sensitive adhesive, for example. In manufacture, sheets of adhesive can be applied to sheets of application pads and then the sheets of application pads and adhesive can be cut to size. The application pad 76 can be any size or shape, and in an exemplary embodiment, the application pad 76 is 0.4375 inches thick×1.5 inches wide×4.75 inches long, with rounded corners.

In an exemplary embodiment, the application pad 76 can absorb and dispense a fluid, such as a lubricant. In other exemplary embodiments, the application pad 76 can distribute a fluid, such as a lubricant, that has already been provided on a surface, such as a surface of a treadmill running belt or a running panel that supports the running belt. In any case, the fluid can comprise liquid lubricants and can include, for example, liquid silicone, such as Dow Corning 200® Fluid (350, 500, or 1000 centistokes) medium viscosity silicone fluids and/or GE SF96® (350, 500, or 1000 centistokes) silicone fluids. The fluid might also comprise liquid waxes or any other kind of liquid lubricant (including liquid lubricants used particularly in treadmill applications).

Further, the fluid might be provided in a container, such as a plastic bottle or a packet (similar to “ketchup packets,” for example). In an exemplary embodiment, the fluid can be provided in ¼ ounce packets. Other examples are possible as well. A user can then dispose the fluid onto the application pad 76 for absorption and/or dispensing. Further, the fluid and the application device 20 might be sold together in a kit or as a kit. Other examples are possible, as well.

5. Fourth Exemplary Embodiment

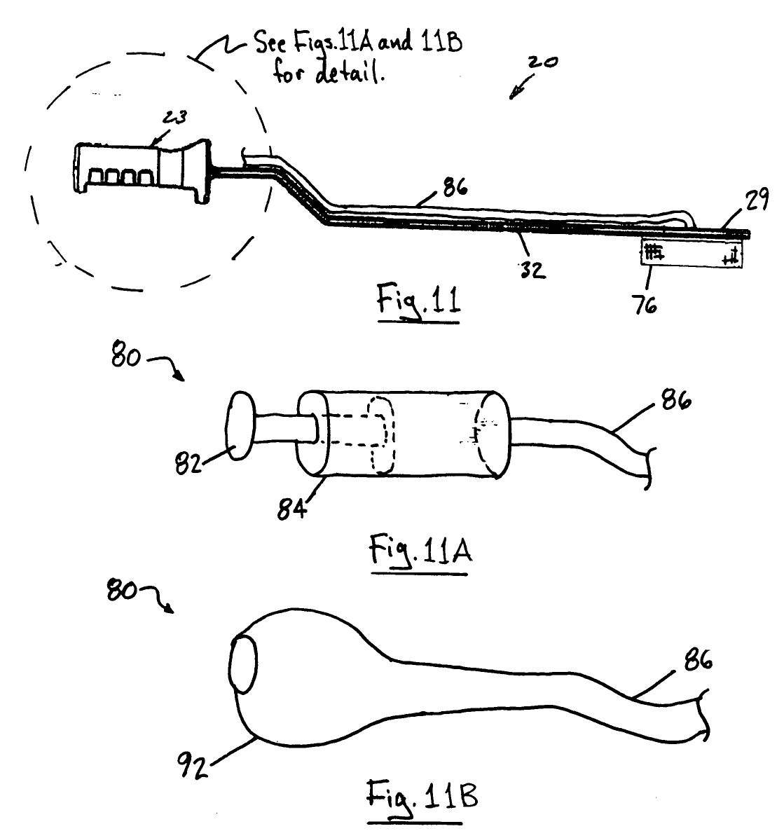

FIG. 11 depicts an exemplary application device 20. The exemplary embodiment depicted in FIG. 11 expands upon the exemplary embodiment depicted in FIG. 10, and can comprise the hand grip 23, the body 32, the mounting platter 29, and the application pad 76.

In the exemplary embodiment depicted in FIG. 11, a fluid might be disposed onto (and/or into) the application pad 76 via a dispensing device 80. Further, the dispensing device 80 might be mounted on the application device 20, for example on the body 32 or inside or on the hand grip 23 of the application device 20. The dispensing device 80 might also be mounted such that a user can actuate the dispensing device and/or dispose lubricant on the application pad 76 while the user is holding the application device 20 at the hand grip 23.

FIGS. 11A and 11B depict exemplary dispensing devices. FIG. 11A depicts an exemplary dispensing device 80, which might be a syringe-type device and which might comprise a plunger 82, a barrel 84, and an outlet tube 86. In this exemplary embodiment, fluid can be disposed in the barrel 84 and dispensed through the outlet tube 86 by actuation of the plunger 82. FIG. 11B depicts an exemplary dispensing device 80, which might be a bulb-type (or other squeeze-type) device and which might comprise a bulb 92 and an outlet tube 86. In this exemplary embodiment, fluid can be disposed in the bulb 92 and dispensed through the outlet tube 86 by actuation of the bulb 92. Other examples are possible as well. The dispensing device 80 can be any size or volume, including 15, 18, 20, or 25 cubic centimeters, and in an exemplary embodiment, the dispensing device is a syringe-type device that can hold 15 cubic centimeters of fluid.

In an exemplary embodiment, the outlet tube 86 can fluidly communicate with the application pad 76. The outlet tube 86 might comprise a flexible material, such as vinyl, for example. From the outlet of the dispensing device 80, the outlet tube 86 might run along the body 32 to the mounting platter 29. There might then be an opening in the mounting platter 29 (and an opening in any adhesive or adhesive material attached to the mounting platter 29 and/or the application pad 76) to receive the outlet tube 86. The outlet tube 86 might then deliver fluid, such as a lubricant, to the application pad 76 through the opening. Other examples are possible, as well.

6. Exemplary Operation

The list below depicts functions that might be involved in using an exemplary application device 20 to lubricate a treadmill.

a. Unplug the treadmill.

b. Clean dirt and foreign matter from treadmill.

c. Grip the hand grip 23 and lift the side of running belt slightly to expose the surface of the running panel.

d. Extend the body 32 and the mounting platter 29 between the running belt and deck surface parallel to the running panel, and apply lubricant to the deck surface such as by using a longitudinal or side-to-side motion while pressing the application area 26 downwardly parallel onto the deck surface.

e. Remove the body 32 and the mounting platter 29 from between the belt and the deck surface.

f. The treadmill is now cleaned and lubricated for use.

7. Conclusion

Several exemplary embodiments of the present invention have been described above. Those skilled in the art will understand, however, that changes and modifications may be made to these embodiments without departing from the true scope and spirit of the present invention, which is defined by the claims.

We claim:

1. An applicator for applying a lubricant to an apparatus comprising:
an elongated body connected to an application area, wherein the elongated body comprises an offset.

2. The applicator of claim 1, wherein the application area comprises a wax block.

3. The applicator of claim 1, wherein the application area comprises an absorptive pad.

4. An apparatus maintenance kit comprising:
a lubricant;
an applicator for applying the lubricant to an apparatus, the applicator comprising an elongated body connected to an application area, wherein the elongated body comprises an offset.

5. The applicator kit of claim 4, wherein the application area comprises an absorptive pad.

6. A method for lubricating the surface of an apparatus, the method comprising:
manually operating an applicator for applying a lubricant to an apparatus, the applicator comprising an elongated body connected to an application area, wherein the elongated body comprises an offset.

7. The applicator of claim 1, wherein the application area comprises a wax block.

8. The applicator of claim 1, wherein the application area comprises an absorptive pad.
